(19) United States
(12) Patent Application Publication
(10) Pub. No.: US 2014/0084709 A1
(43) Pub. Date: Mar. 27, 2014

(54) STRIP STATOR

(71) Applicant: Zhongshan Broad-Ocean Motor Manufacturing Co., Ltd., (US)

(72) Inventors: Songfa TANG, Zhongshan (CN); Chongsheng ZENG, Zhongshan (CN)

(73) Assignee: Zhongshan Broad-Ocean Motor Manufacturing Co., Ltd., Zhongshan (CN)

(21) Appl. No.: 13/844,963

(22) Filed: Mar. 16, 2013

(30) Foreign Application Priority Data
Sep. 27, 2012 (CN) 201220509914.7

(51) Int. Cl. H02K 1/12

(52) U.S. Cl. CPC H02K 1/12
USPC 310/12.24

(57) ABSTRACT

A strip stator including: a strip stator core; a plurality of upper end insulation groups; and a plurality of lower end insulation groups. The stator core includes two ends. Each upper end insulation group includes at least two upper end insulations connected together by injection molding. Each lower end insulation group includes at least two lower end insulations connected together by injection molding. The upper end insulation groups and the lower end insulation groups are arranged on the two ends of the strip stator core, respectively.

### CROSS-REFERENCE TO RELATED APPLICATIONS

Pursuant to 35 U.S.C. §119 and the Paris Convention Treaty, this application claims the benefit of Chinese Patent Application No. 201220509914.7 filed Sep. 27, 2012, the contents of which are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a strip stator structure and belongs to the motor field.

2. Description of the Related Art

A typical strip stator structure includes a stator core and an end insulation that are connected together by injection molding. However, the process of the injection molding is difficult and expensive. To solve this problem, the end insulation is usually divided into upper end insulation and lower end insulation. Each part includes a plurality of units. As the units are separated from one another, it is troublesome in installation, thereby lowering the production efficiency and increasing the labor cost.

### SUMMARY OF THE INVENTION

In view of the above-described problems, it is one objective of the invention to provide a strip stator structure that has a simple structure, low technical difficulty, high efficiency in assembly and installation, and low production cost.

To achieve the above objective, in accordance with one embodiment of the invention, there is provided a strip stator structure, comprising: a strip stator core comprising two ends; a plurality of upper end insulation groups, each upper end insulation group comprising at least two upper end insulations connected together by injection molding; and a plurality of lower end insulation groups, each lower end insulation group comprising at least two lower end insulations connected together by injection molding. The upper end insulation groups and the lower end insulation groups are arranged on the two ends of the strip stator core, respectively.

In a class of this embodiment, the strip stator core comprises a tooth tip, and the tooth tip is wrapped by the upper end insulations and the lower end insulations.

In a class of this embodiment, the upper end insulation groups comprise an end surface, and an outer edge of the end surface of the upper end insulation groups is convex to form a stiffening edge.

In a class of this embodiment, two upper end insulation groups are provided, and each upper end insulation group comprises six upper end insulations.

In a class of this embodiment, two lower end insulation groups are provided, and each lower end insulation group comprises six lower end insulations.

Advantages of the invention are summarized as follows:
1) The strip stator of the invention comprises: the strip stator core, a plurality of the upper end insulation groups, and a plurality of the lower end insulation groups; each upper end insulation group comprises at least two upper end insulations connected together by injection molding; each lower end insulation group comprises at least two lower end insulations connected together by injection molding; thereby simplifying the structure, lowering the technical difficulty and the production cost, simplifying the assembly process, and improving the installation efficiency.
2) The tooth tip of the strip stator core is wrapped by the upper end insulations and the lower end insulations. When the strip stator bends, adjacent tooth tips are well isolated from each other by insulation, thereby meeting the requirement of high-voltage motors.
3) The outer edge of the end surface of the upper end insulation groups is convex to form the stiffening edge, thereby improving the intensity, and preventing the end insulation from fracture.

### BRIEF DESCRIPTION OF THE DRAWINGS

The invention is described hereinbelow with reference to the accompanying drawings, in which:

FIG. 1 is a stereogram of a strip stator structure in accordance with one embodiment of the invention;

FIG. 2 is an enlarged view of part A-A of FIG. 1;

FIG. 3 is an enlarged view of part B-B of FIG. 1; and

FIG. 4 is an exploded view of a strip stator in accordance with one embodiment of the invention.

### DETAILED DESCRIPTION OF THE EMBODIMENTS

For further illustrating the invention, experiments detailing a strip stator structure are described below. It should be noted that the following examples are intended to describe and not to limit the invention.

### Example 1

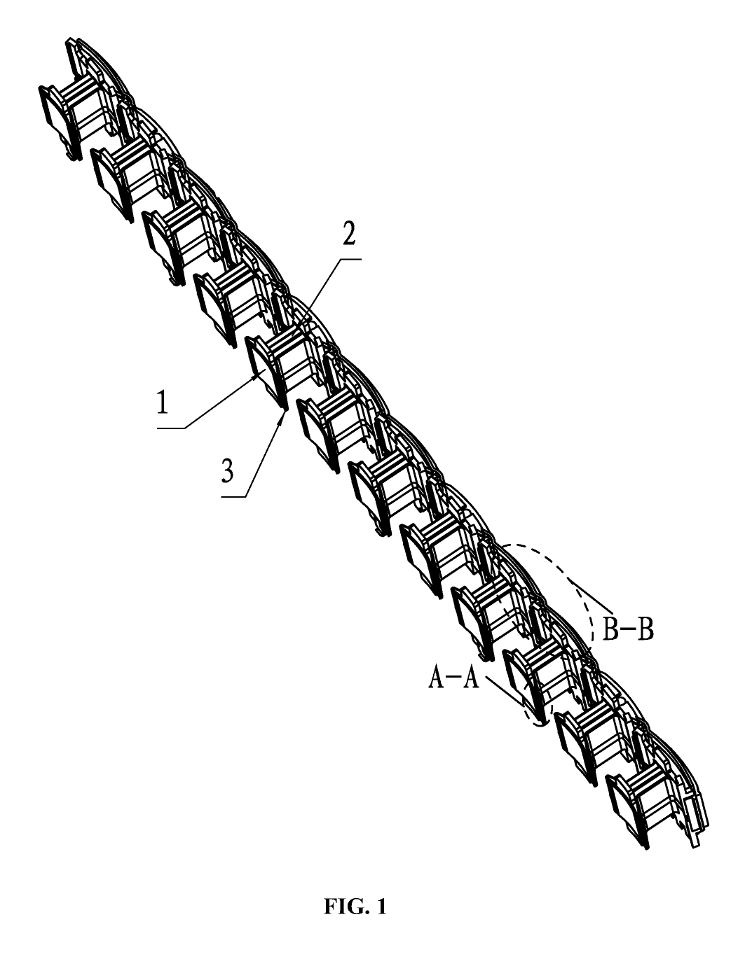

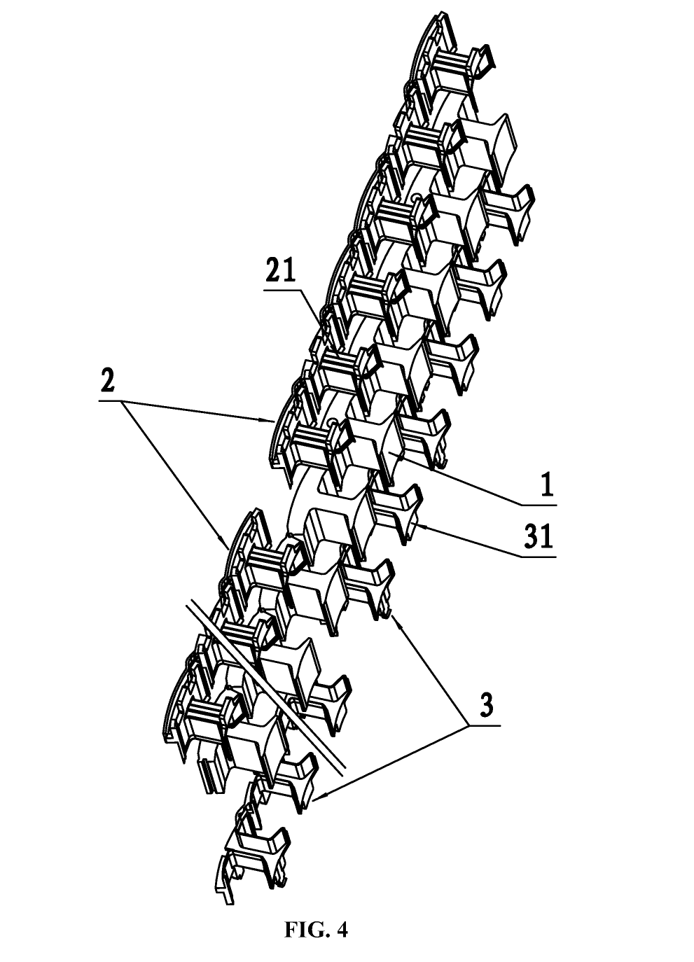

As shown in FIG. 1 and FIG. 4, a strip stator structure comprises: a strip stator core 1, a plurality of upper end insulation groups 2, and a plurality of lower end insulation groups 3. Each upper end insulation group 2 comprises at least two upper end insulations 21 connected together by injection molding. Each lower end insulation group 3 comprises at least two lower end insulations 31 connected together by injection molding. The upper end insulation groups 2 and the lower end insulation groups 3 are arranged on two ends of the strip stator core 1, respectively.

### Example 2

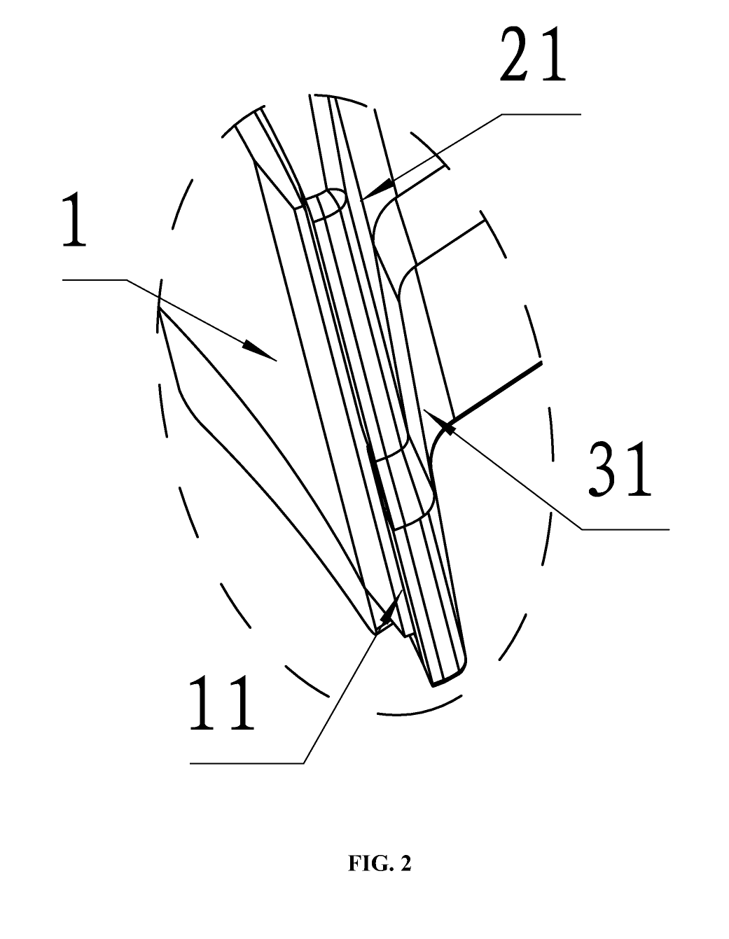

As shown in FIG. 2, based on Example 1, the following technical feature is added: the strip stator core 1 comprises a tooth tip 11, and the tooth tip 11 is wrapped by the upper end insulations 21 and the lower end insulations 31.

### Example 3

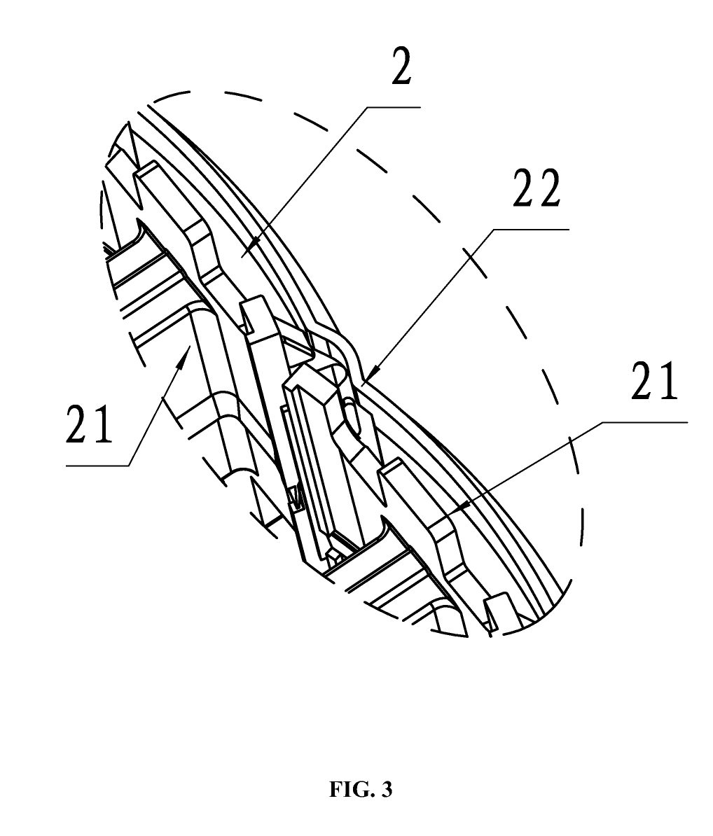

As shown in FIG. 3, based on Example 1, the following technical feature is added: the upper end insulation groups 2 comprises an end surface, and an outer edge of the end surface of the upper end insulation groups 2 is convex to form a stiffening edge 22.

### Example 4

As shown in FIG. 4, based on Example 1, 2, or 3, the following technical features are added: two upper end insulation groups 2 are provided, and each upper end insulation group 2 comprises six upper end insulations 21.

### Example 5

As shown in FIG. 4, based on Example 1, 2, or 3, the following technical features are added: two lower end insulation groups 3 are provided, and each lower end insulation group 3 comprises six lower end insulations 31.

The strip stator of the invention divides the traditional end insulation into a plurality of the upper end insulation groups 2 and a plurality of the lower end insulation groups 3. Each of the upper end insulation groups 2 comprises at least two upper end insulations 21 connected together by injection molding. Each of the lower end insulation groups 3 comprises at least two lower end insulations 31 connected together by injection molding. Thus, the manufacturing process is improved, the production cost is lowered, and the efficiency of assembly and installation are improved.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A strip stator, comprising:
a) a strip stator core (1) comprising two ends;
b) a plurality of upper end insulation groups (2), each upper end insulation group (2) comprising at least two upper end insulations (21) connected together by injection molding; and
c) a plurality of lower end insulation groups (3), each lower end insulation group (3) comprising at least two lower end insulations (31) connected together by injection molding;
wherein
the upper end insulation groups (2) and the lower end insulation groups (3) are arranged on the two ends of the strip stator core (1), respectively.

2. The strip stator of claim 1, wherein the strip stator core (1) comprises a tooth tip (11), and the tooth tip (11) is wrapped by the upper end insulations (21) and the lower end insulations (31).

3. The strip stator of claim 1, wherein the upper end insulation groups (2) comprise an end surface, and an outer edge of the end surface of the upper end insulation groups (2) is convex to form a stiffening edge (22).

4. The strip stator of claim 1, wherein two upper end insulation groups (2) are provided, and each upper end insulation group (2) comprises six upper end insulations (21).

5. The strip stator of claim 2, wherein two upper end insulation groups (2) are provided, and each upper end insulation group (2) comprises six upper end insulations (21).

6. The strip stator of claim 3, wherein two upper end insulation groups (2) are provided, and each upper end insulation group (2) comprises six upper end insulations (21).

7. The strip stator of claim 1, wherein two lower end insulation groups (3) are provided, and each lower end insulation group (3) comprises six lower end insulations (31).

8. The strip stator of claim 2, wherein two lower end insulation groups (3) are provided, and each lower end insulation group (3) comprises six lower end insulations (31).

9. The strip stator of claim 3, wherein two lower end insulation groups (3) are provided, and each lower end insulation group (3) comprises six lower end insulations (31).
